(19) United States
(12) Patent Application Publication
(10) Pub. No.: US 2011/0075036 A1
(43) Pub. Date: Mar. 31, 2011

(54) AMBIENT ILLUMINATION SYSTEM, DISPLAY DEVICE AND METHOD OF GENERATING AN ILLUMINATION VARIATION AND METHOD OF PROVIDING A DATA SERVICE

(75) Inventors: Guido Galeazzi, Eindhoven (NL); Cornelis Wilhelmus Kwisthout, Eindhoven (NL); Willem Franciscus Johannes Hoogenstraaten, Eindhoven (NL)

(73) Assignee: KONINKLIJKE PHILIPS ELECTRONICS N.V., EINDHOVEN (NL)

(21) Appl. No.: 12/994,184

(22) PCT Filed: May 28, 2009
(86) PCT No.: PCT/IB2009/052253

§ 371 Date: Nov. 23, 2010

(30) Foreign Application Priority Data
Jun. 4, 2008 (EP) 08157563.1

(51) Int. Cl. H04N 5/58

(52) U.S. Cl. 348/602; 348/E05.12

(57) ABSTRACT

The invention relates to an Ambient illumination system (100), a display device (200), and a method of generating an illumination variation. The ambient illumination system generates the illumination variation using an ambilight signal (A, (A_{1,1}. . . A_{4,5}), P, (P_{1,1}, . . . P_{4,5})) derived from a video-image (I₁, I₂), the ambient illumination system comprises an analyzer for deriving the ambilight signals from the video-image and comprises a controller (10) for driving the light source (L1, L2, . . . L8) using the ambilight signal. The illumination variation is displayed by the controller while not displaying the video-image. The effect of the ambient illumination system according to the invention is that it enables to enhance the usability of the ambient illumination system by using the ambiance created by the ambient illumination system via, for example, a previously shown video-image, however, now at a time when the video-image is not shown on the display device which, for example, is located in the same room.

### FIELD OF THE INVENTION

The invention relates to an ambient illumination system for driving a light source ( ) to display a temporal illumination variation.

The invention also relates to a display device, to a method of generating an illumination variation and to a method of providing a data service.

### BACKGROUND OF THE INVENTION

A recent development in display technology is the adding of ambient light effects using an ambient light illumination system to enhance the visual experience when watching content displayed on the display device. This ambient light effect illuminates the surroundings of the display device, such as a television, with light associated with the content of the image currently displayed on the display device. For example, the ambient light effect is generated using an ambient light system which is part of the display device. The illumination system may illuminate a wall behind the display device with light associated with the content of the image. Alternatively, the display device may be connected to a remotely located illumination system for remotely generating the light associated with the content of the image. When the display device displays a sequence of images, for example, a sequence of video frames being part of video content, the content of the images shown in the sequence generally change over time which results in the light associated with the sequence of images to also change over time.

Such an ambient light projection system is disclosed in EP 1 551 178, which discloses a supplementary visual display system for use in conjunction with a display device. The display device presents an image to a viewer. The known ambient light projection system comprises one or more illumination sources which at least partially peripherally project illumination radiated from the illumination sources so as to illuminate a region visually appearing to the viewer to at least partially peripherally surround the image display region. The known ambient light projection system further comprises monitoring components for monitoring audio and/or video content, and comprises controlling components for controlling light radiation emitted in use from the one or more illumination sources in response to the audio and/or video content.

A drawback of the known ambient light projection system is that its usability is limited.

### SUMMARY OF THE INVENTION

It is an object of the invention to provide an ambient illumination system having improved usability.

According to a first aspect of the invention the object is achieved with an ambient illumination system for driving a light source to display an illumination variation, the illumination variation being generated using an ambilight signal derived from a video-image, the ambilight signal comprising a peak value or average value of a color and/or intensity from a predefined area of the video-image, the ambient illumination system comprising:

an analyzer for deriving the ambilight signal from the video-image, and

a controller for driving the light source using the ambilight signal to display the illumination variation while not displaying the video-image.

The effect of the measures according to the invention is that the illumination variation displayed by the ambient illumination system according to the invention is based on a video-image and is not linked to a screen-content of the display device which is, for example, located in the room. The ambient illumination system according to the invention provides an illumination variation which is displayed while not displaying the video-image from which the ambilight signal is derived. This provides the possibility to enhance the usability of the ambient illumination system by using the ambiance created by the ambient illumination system via, for example, a previously shown video-image, however, now at a time when the video-image is not shown on the display device which is in the same room. Using the ambient illumination system according to the invention enables a user to generate the illumination variation associated with a video-image watched earlier. For example, when a movie shown on a display device has ended, the ambient illumination system may continue to display the illumination variation associated with the movie while the display device is switched off. As a result, the ambiance which was created by the movie inside a room is prolonged after the movie. Alternatively, the ambient illumination system according to the invention may be used to support and/or create a specific mood in the user. The ambient illumination system may display the illumination variation which, for example, is extracted from an image representing a relaxing mood. As such the ambient illumination system may help the user to relax more easily and/or more quickly. Also other different ambiances may be generated by the illumination variation shown by the ambient illumination system according to the invention, such as, for example, a romantic-ambiance, an action-ambiance, a horror-ambiance, or, for example, a humorous-ambiance may be created in a room in which each of the generated ambiances are related to a video-image or movie.

The illumination variation generated by the ambient illumination system may, for example, comprise a variation in color and/or a variation in intensity of the generated light in time. Furthermore, the variation of the ambient light effect may, for example, comprise a spatial variation and/or a temporal variation of the color and/or intensity, for example, over an illuminated projection surface over time.

In the known ambient light projection system the variation of the light emitted by the ambient light projection system is closely related to the video-image which is simultaneously displayed on the display device. Typically the illumination variation which is generated by the known ambient light projection system is generated in real-time and thus displayed when the video-image is displayed to enhance the viewing experience of the video-image. The illumination variation of the known ambient light projection system may lag somewhat behind the video-image of the display device to reduce eye-strain for a user. Still, the video-image from which the illumination variation is extracted is shown substantially simultaneously and substantially synchronized with the illumination variation of the known ambient light projection system. A prerecorded movie may comprise an ambilight signal defining the temporal illumination variation related to the prerecorded movie. However, also this ambilight signal is synchronized with the prerecorded movie and displayed simultaneously to enhance the viewing experience of the movie. The ambient illumination system according to the invention displays the illumination variation while not displaying the video-image. The ambient illumination system according to the invention comprises an analyzer which derives the ambilight signal from the video-image which is subsequently used to drive the light source to generate the illumination variation. As a result, the ambiance created by the ambient illumination system by generating the illumination variation associated with a movie may, for example, be prolonged until after the movie has ended, or may be generated separately from the displaying of the movie to, for example, mimic the ambiance of the movie, for example, after the movie has ended or at some other time.

Currently, Philips has published a light source known under the commercial name of “Livingcolors”™ which may display different colors of light. In a special promotional version of this “Livingcolors”™ lamp, the lamp continuously alters the color of the light source in a continuous loop. The ambient illumination system according to the invention is different from the promotional version of the “Livingcolors”™ lamp in that the ambient illumination system according to the invention generates the illumination variation using the ambilight signal extracted from a video-image. The ambient illumination system according to the invention comprises the analyzer for deriving the ambilight signal from the image and comprises the controller which uses this ambilight signal to generate the illumination variation. The special promotional version of the “Livingcolors”™ lamp only comprises a continuous loop of altering the colors emitted by the “Livingcolors”™ lamp such that a person wanting to buy such a lamp would see the broad range of possible colors which can be generated by the “Livingcolors”™ lamp. The continuous loop of altering colors in the “Livingcolors”™ lamp is not extracted from a video-image.

Some known display devices have two separate modes for using the ambient illumination system. In a first mode the ambient illumination system displays a sequence of colors while the display of the display device is switched off. In this first mode, the illumination variation is not based on the ambilight signal derived from the analyzer from the video-image, but is based on a prerecorded sequence of colors which is provided to the ambient illumination system in a continuous loop. In this first mode of operation the analyzer of the known display device is idle. In a second mode of operation the known display device displays the illumination variation associated with the video currently on display, and thus the illumination variation is synchronized with the video on display. In this second mode of operation the analyzer of the known display device derives the ambilight signals from the displayed video. In the ambient illumination system according to the invention the ambient illumination system comprises the analyzer which derives the ambilight signal from the video-image and provides the derived ambilight signal to the controller for driving the light source. The illumination variation is associated with the video-image but the video-image is not shown simultaneously. As such, the analyzer has to analyze the video-image to while the video-image is not displayed.

In an embodiment of the ambient illumination system, the ambient illumination system is configured for receiving the video-image from a source. The source may comprise a storage medium or a tuner or, for example, a web-cam which is remotely located from the ambient illumination system. The storage medium may, for example, be a digital video disc or may, for example, be a non-volatile memory.

In an embodiment of the ambient illumination system, the ambient illumination system (100) further comprises a recorder for recording the ambilight signal derived from the video-image onto a storage medium. A benefit of this embodiment is that the recorder records the ambilight signal only which may be displayed at a later stage. Due to the only recording of the ambilight signal, the storage capacity may be limited to still provide an ambiance related to the video-image when the ambilight signal is displayed separate from the video-image. The ambient illumination system according to the invention may comprise a memory module for storing the ambilight signal, for example, for later retrieval by the controller.

In an embodiment of the ambient illumination system, the analyzer is configured for deriving a series of peak values or a series of average values of the predefined area from the video-image collected at predetermined time intervals. A benefit of this embodiment is that the series of peak values or the series of average values generate the ambilight signal over time. For example, the recorder may record the ambilight signal using the peak values or average values from a favorite part of a movie or of a whole movie. This prerecorded ambilight signal may be used later to display the predetermined illumination variation which generates the ambiance which corresponds to the favorite part of a movie or of a whole movie.

In an embodiment of the ambient illumination system, the analyzer is configured for averaging the derived peak values over time to generate the ambilight signal, or wherein the analyzer is configured for averaging the derived average value over time to generate the ambilight signal. The average value which is derived from the video-image is averaged over the predefined area of the video-image. In the current embodiment, the series of average values averaged over the predefined area are subsequently averaged over time. A benefit of this embodiment is that the averaging of the peak value or average value over time prevents abrupt changes in the illumination. By averaging the illumination changes over time a smoothed illumination variation is generated which reduces the eye strain of a user while maintaining the ambiance of the video-image or movie from which the ambilight signal is derived. Abrupt changes in the ambient illumination when the ambient illumination is synchronized with the video-image on display may have a clear effect in the video-image on display. For example, an exciting or tense moment in a movie may require the synchronous ambient illumination to abruptly alter the illumination to emphasize the exciting or tense moment. However, when displaying the ambilight signal based on the movie separate from the displaying of the movie, the abruptly changing illumination may distract rather than contribute to the overall ambiance of the movie. By filtering out these abrupt changes, the ambiance of the movie is maintained without the distracting effect.

In an embodiment of the ambient illumination system, the controller is configured for generating interpolation values in-between the peak values in the series of peak values or in-between the average values in the series of average values for generating a smooth transition from one peak value to the next peak value in the series of peak values or from one average value to the next average value in the series of average values. A benefit of this embodiment is that by smoothing the transitions from one peak value to the next or from one average value to the next the eye-strain of a user of the ambient illumination system may be reduced. When watching content displayed on the display device the ambient light effect may, next to an enhancement of the visual experience, also be applied to reduce eye strain. A variation in color and/or intensity from one image to another in video content may be relatively large. Using the ambient light system to illuminate the surroundings of the display device reduces the perceived large color and/or intensity variation from one image displayed on the display device to another, which reduces eye strain. This effect may also be used in the ambient illumination system according to the invention in which in-between values are created to smoothen the transition from one peak value to the next or one average value to the next thus reducing the eye-strain while maintaining the ambiance of the video-image from which the ambilight signal is derived.

Furthermore, the interpolation between peak values or between average values reduces the memory size required for storing the ambilight signal by the recorder. The controller generates the in-between values, for example, when displaying the illumination variation based on the prerecorded ambilight signal.

Alternatively, the recorder may generate the in-between peak values in the series of peak values or the in-between average values in the series of average values to smoothen the transition between peak values or between average values.

In an embodiment of the ambient illumination system, the controller is configured for adapting a time-scale of the ambilight signal to increase or decrease a time required for displaying of the illumination variation. A benefit of this embodiment is that a relatively short ambilight signal representing the ambiance of a movie may be extended over several hours to stretch the experience of a user even further.

In an embodiment of the ambient illumination system, the analyzer is configured for deriving the ambilight signal from a sequence of video-images. A benefit of this embodiment is that a pre-selected favorite scene of a sequence of video-images or of a short movie may be used. For example, using a favorite scene comprising waves or skies or showing sunrise or sunset may be used to derive the ambilight signal. Using, for example, a movie showing sunrise for generating the associated illumination variation, this associated illumination variation may be displayed when the user has to wake-up to gradually increase the light levels in the room in a manner mimicking sunrise. Alternatively, using, for example, a movie showing sunset for generating an alternative illumination variation, this alternative illumination variation may be displayed when the user goes to sleep to reduce the light levels in the room in a manner mimicking the sunset.

The video-image showing the sunset or sunrise may alternatively be provided via a web-cam, for example, showing the sunset or sunrise at a Caribbean beach for deriving the ambilight signal from.

Also other favorite scenes like, for example, forest, raindrops, flowers, disco and candle light may be used to generate the ambilight signal.

Alternatively, the sequence of video-images may be generated using a predefined algorithm. In such an embodiment, a video-image may comprise a specific distribution of colors which distribution is changed using the predefined algorithm to generate the subsequent video-image in the sequence of video-images.

In an embodiment of the ambient illumination system, the analyzer is configured for deriving the ambilight signal by moving the predefined area across the video-image. In such an embodiment, the video-image may, for example, be a still-image comprising a specific range of colors. The specific range of colors may be chosen to represent a specific mood of a user or the specific range of colors may have sub-areas which represent the specific mood of the user. A benefit of this embodiment is that by having the predefined area moving across the video-image, the illumination variation may vary continuously according to the range of colors in the video-image. A user may, for example, indicate the mood he is in, for example, romantic mood or may, for example, choose a favorite video-image. The ambient illumination system according to the invention subsequently generated the ambilight signal derived from the selected video-image by moving the predefined area across the video-image. The moving of the predefined area may be done before the ambient illumination system displays the illumination variation, or the moving of the predefined area may be done in the controller without the chosen video-image being visible on the display device.

In an embodiment of the ambient illumination system, the analyzer is configured for moving of the predefined area along a user defined path within the video-image. A benefit of this embodiment is that a user may define the path or loop which is used to move the predefined area along to generate the illumination variation. In such an embodiment, the user is in full control of the illumination variation. In an embodiment of the ambient illumination system, the analyzer is configured for moving the predefined area along a predefined path within the video-image. The predefined path within the video-image may be predefined by a retailer of the ambient illumination system and may, for example, be stored in a memory module of the ambient illumination system. By recalling the predefined path, the user may enjoy the illumination variation. In an embodiment of the ambient illumination system, the analyzer is configured for moving the predefined area along a random path within the video-image. A benefit of this embodiment is that the illumination variation never provides exactly the same experience to a user as the variation is different every time the ambient illumination system is used with a certain video-image. In an embodiment of the ambient illumination system, the analyzer is configured for moving the predefined area within a predefined sub-area of the video-image. A benefit of this embodiment is that a single video-image may have different sub-areas which, for example, comprise different colors associated with specific moods. The user may then limit the moving of the predefined area to within the predefined sub-area which corresponds to his current mood.

In an embodiment of the ambient illumination system, the recorder records the ambilight signal by:

storing the peak values or average values using between 8 pixel and 32 pixel for every color, and/or

defining a color of the peak value or average value to be stored by defining the contributions of at least three primary color, and/or

sampling the peak values or the average values at a rate between 1 and 60 values per second.

A benefit of this embodiment is that a size of the memory module required to store the ambilight signal may be limited.

According to a second aspect of the invention the object is achieved with a display device as claimed in claim 11. According to a third aspect of the invention the object is achieved with a method of generating an illumination variation as claimed in claims 12, 13 and 14. According to a fourth aspect of the invention the object is achieved with a method of providing a data service via a data-network as claimed in claim 15.

### BRIEF DESCRIPTION OF THE DRAWINGS

These and other aspects of the invention are apparent from and will be elucidated with reference to the embodiments described hereinafter.

In the drawings:

FIG. 1 shows a schematic representation of the ambient illumination system according to the invention,

FIG. 2A shows a display device having a plurality of predefined areas for deriving the ambilight signal from, and FIG. 2B shows a display device having a single predefined area which moves within the image for deriving the ambilight signal, and

FIG. 3 shows the ambient illumination system comprising a plurality of light sources distributed throughout a room.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF EMBODIMENTS

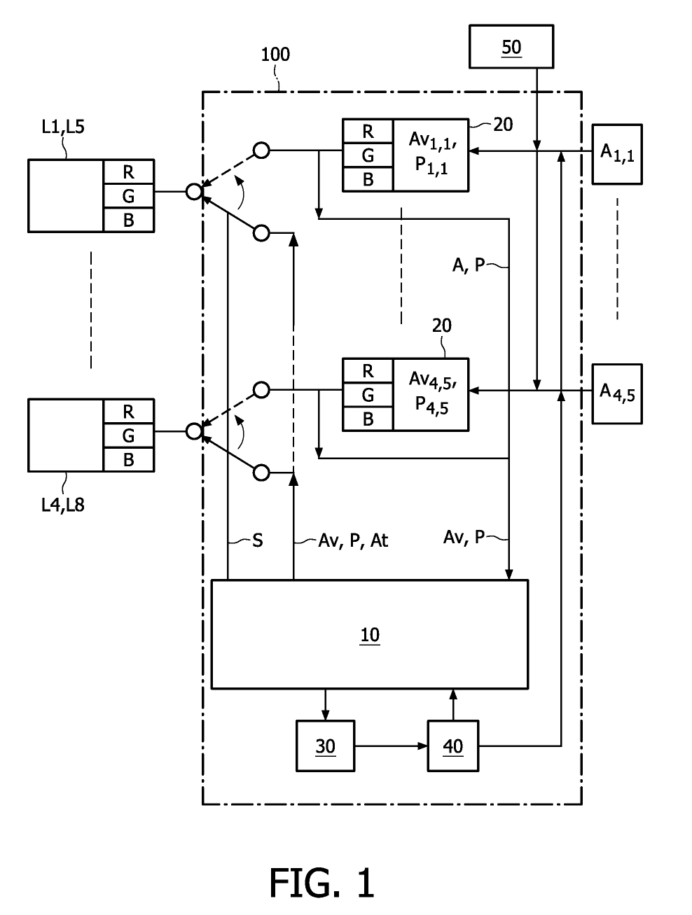

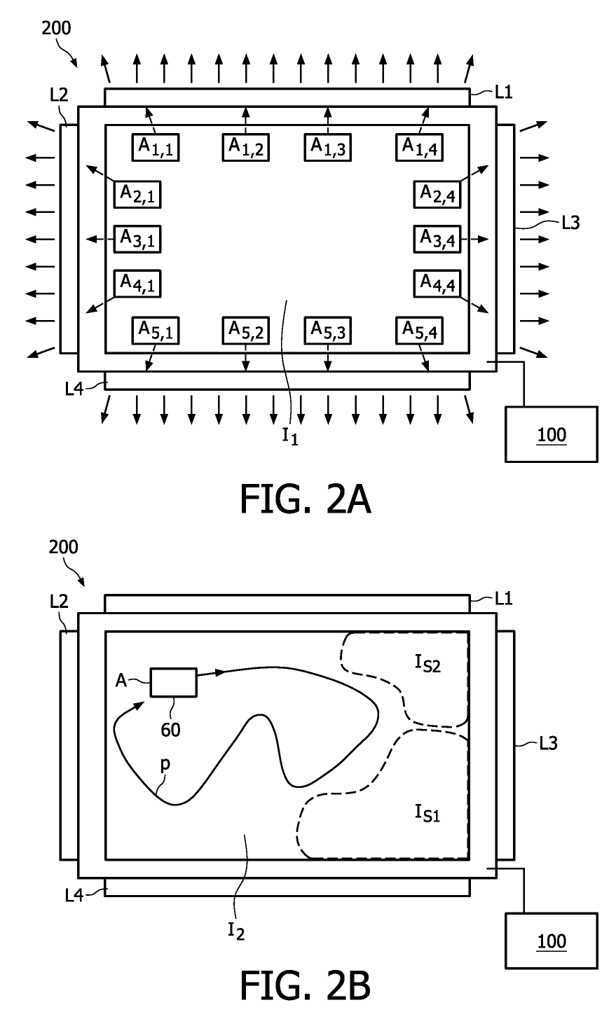

FIG. 1 shows a schematic representation of the ambient illumination system 100 according to the invention. The ambient illumination system 100 comprises a controller 10 and an analyzer 20. The analyzer 20 derives an ambilight signal Av, At (Av_{1,1}, . . . Av_{4,5}), P, (P_{1,1}, . . . P_{4,5}) from a video-image I₁, I₂ (see FIGS. 2A and 2B). The video-image I₁ may comprise a sequence of video-images I₁ which, for example, constitute a movie or part of a movie. When the video-image I₁ is (part of) a movie, the ambilight signal Av, At (Av_{1,1}, . . . Av_{4,5}), P, (P_{1,1}, . . . P_{4,5}) is generally derived from a plurality of predefined areas A, (A_{1,1}, . . . A_{4,5}) distributed at predetermined locations of the video-image I₁ and from which a peak-value P, (P_{1,1}, . . . P_{4,5}) for each of the predefined areas A, (A_{1,1}, . . . A_{4,5}) is determined or from which an average value Av, (Av_{1,1}, . . . Av_{4,5}) for each of the predefined areas A, (A_{1,1}, . . . A_{4,5}) is determined. The peak value P, (P_{1,1}, . . . P_{4,5}) generally represents a maximum intensity value of the illumination level of the image I₁ within the predefined area A, (A_{1,1}, . . . A_{4,5}), for example, for each of the three primary colors R, G, B. The average value Av, (Av_{1,1}, . . . Av_{4,5}) represents an average intensity of the illumination level of the predefined area A, (A_{1,1}, . . . A_{4,5}), for example, for each of the three primary colors R, G, B.

The ambilight signal Av, At (Av_{1,1}, . . . Av_{4,5}), P, (P_{1,1}, . . . P_{4,5}) may be the peak value P, (P_{1,1}, . . . P_{4,5}) or the average value Av, (Av_{1,1}, . . . Av_{4,5}) determined from the predefined area A, (A_{1,1}, . . . A_{4,5}). Alternatively, the ambilight signal Av, At (Av_{1,1}, . . . Av_{4,5}), P, (P_{1,1}, . . . P_{4,5}) may be a time averaged ambilight signal At generated by time-averaging the sensed peak value P, (P_{1,1}, . . . P_{4,5}) or generated by time-averaging the sensed average value Av, (Av_{1,1}, . . . Av_{4,5}).

The sequence of video-images I₁, I₂ may a pre-selected favorite scene of a sequence of video-images I₁, I₂ or of a short movie I₁, I₂ may be used. For example, using a favorite scene I₁, I₂ comprising waves or skies or showing sunrise or sunset may be used to derive the ambilight signal Av, At (Av_{1,1} , . . . Av_{4,5}), P, (P_{1,1}, . . . P_{4,5}). Using, for example, a movie I₁, I₂ showing sunrise for generating the associated illumination variation, this associated illumination variation may be displayed when the user has to wake-up to gradually increase the light levels in a room in a manner mimicking sunrise. Alternatively, using, for example, a movie I₁, I₂ showing sunset for generating an alternative illumination variation, this alternative illumination variation may be displayed when the user goes to sleep to reduce the light levels in the room in a manner mimicking the sunset. Also other favorite scenes I₁, I₂ like, for example, forest, raindrops, flowers, disco and candle light may be used to generate the ambilight signal Av, At (Av_{1,1}, . . . Av_{4,5}), P, (P_{1,1}, . . . P_{4,5}). Alternatively, the sequence of video-images I₁, I₂ may be generated using a predefined algorithm. In such an embodiment, a video-image I₁, I₂ may comprise a specific distribution of colors which distribution is changed using the predefined algorithm to generate the subsequent video-image I₁, I₂ in the sequence of video-images I₁, I₂.

Alternatively, the video-image I₂ may be a still-image I₁, I₂ or part of a still-image I₁, I₂ from which the ambilight signal Av, At (Av_{1,1}, . . . Av_{4,5}), P, (P_{1,1}, . . . P_{4,5}) is derived. This still-image I₁, I₂ may, for example, comprise a predefined variation of colors across the still-image I₁, I₂. The illumination variation may, for example, be generated by moving the predefined area A across the still-image I₁, I₂ which generates a sequence of peak-values P, (P_{1,1}, . . . P_{4,5}) versus time or which generates a sequence of average values Av, (Av_{1,1}, . . . Av_{4,5}) versus time which may be used by the controller 10 to drive the light source L1, L2 . . . , L8 to display the illumination variation. The moving predefined area A may, for example, move along a path p (see FIG. 2B). This path p may be a user defined path p which may, for example, be defined by moving a cursor through the video-image I₁, I₂ defining the path. Alternatively, the path p may be a predefined path p, for example, defined by the retailer or factory from which the ambient illumination system 100 is sold. Further alternatively, the path p may be a random path p within the video-image I₁, I₂ preventing that the experienced illumination variation results in a predictable continuous looping variation of the illumination. Furthermore, the path p may be limited to a sub-area I_{S1}, I_{S2} (see FIG. 2B) of the video-image I₁, I₂. In such an embodiment the sub-areas I_{S1}, I_{S2}, for example, represent a specific range of colors which, for example, are associated with a specific mood of a user. This user defined path p is subsequently used to derive the ambilight signal Av, At (Av_{1,1}, . . . Av_{4,5}), P, (P_{1,1}, . . . P_{4,5}) from to generate the illumination variation. When using such a path p additional control means (not shown) may be provided to a user, such as determining an average intensity of the light generated by the ambient illumination system 100, or a definition of the speed of the moving predefined area A through the video-image I₁, I₂ along the path p, or a maximum intensity of color variation allowed by the ambient illumination system 100 when moving the predefined area A along the path p to limit the amount of eye-strain which may be caused by displaying the illumination variation. This additional control may be provided via a remote control (not shown) or via any other well known means of user interaction with a system or device.

The video-image I₁, I₂ may be received from a source 40, 50, 420. The source 40, 50, 420 may, for example, be a storage medium 40 or a tuner 50. Alternatively, the source 40, 50, 420 may be a web-cam 420 (see FIG. 4) showing some scene or video-image I₁, I₂, for example, of a sunset in the Caribbean which video-image I₁, I₂ is subsequently used for generating the illumination variation while not displaying the video-image I₁, I₂.

The analyzer 20 derives the average value Av, (Av_{1,1}, . . . Av_{4,5}) or peak value P, (P_{1,1}, . . . P_{4,5}) based on the video-image I₁, I₂ to the controller 10. The controller 10 subsequently drives the light source L1, L2, . . . , L8 to display the illumination variation based on the ambilight signal Av, At (Av_{1,1}, . . . Av_{4,5}), P, (P_{1,1}, . . . P_{4,5}).

The ambient illumination system 100 may further comprise a recorder 30 for recording the ambilight signal Av, At (Av_{1,1}, . . . Av_{4,5}), P, (P_{1,1}, . . . P_{4,5}) derived from the video-image I₁, I₂ onto the storage medium 40 generating a prerecorded ambilight signal. This prerecorded ambilight signal may at a later time be used for generating the illumination variation associated with the video-image I₁, I₂ from which the ambilight signal Av, At (Av_{1,1}, . . . Av_{4,5}), P, (P_{1,1}, . . . P_{4,5}) is derived. Only storing the ambilight signal Av, At (Av_{1,1}, . . . Av_{4,5}), P, (P_{1,1}, . . . P_{4,5}) enables the use of the ambient illumination system 100 for generating an ambiance associated with the video-image I₁, I₂ while the size of the storage medium 40 may remain limited. The recorder 30 may record the received ambilight signal Av, At (Av_{1,1}, . . . Av_{4,5}), P, (P_{1,1}, . . . P_{4,5}) by storing the peak values (P, (P_{1,1}, . . . P_{4,5})) or average values (Av, (Av_{1,1}, . . . Av_{4,5})) using between 8 pixel and 32 pixel for every color. The recorder 30 may defining a color of the peak value (P, (P_{1,1}, . . . P_{4,5})) or average value (Av, (Av_{1,1}, . . . Av_{4,5})) to be stored by defining the contributions of at least three primary colors. Furthermore, the recorder 30 may sample the peak values (P, (P_{1,1}, . . . P_{4,5})) or the average values (Av, (Av_{1,1}, . . . Av_{4,5})) at a rate between 1 and 60 values per second. A benefit of this embodiment is that a size of the storage medium 40 required to store the ambilight signal Av, At, (Av_{1,1}, . . . Av_{4,5}), P, (P_{1,1}, . . . P_{4,5}) may be limited.

FIG. 2A shows a display device 200 having a plurality of predefined areas (A_{1,1}, . . . A_{4,5}) from which the ambilight signal Av, At, (Av_{1,1}, . . . Av_{4,5}), P, (P_{1,1}, . . . P_{4,5}) is derived. The display device 200 comprises the ambient illumination system 100 according to the invention to generate the illumination variation associated with the video-image I₁, I₂ while not displaying the video-image I₁, I₂. The illumination variation is shown by deriving the ambilight signal Av, At, (Av_{1,1}, . . . Av_{4,5}), P, (P_{1,1}, . . . P_{4,5}) from the video-image I₁, I₂ by the analyzer 20 which provides the ambilight signal Av, At, (Av_{1,1}, . . . Av_{4,5}), P, (P_{1,1}, . . . P_{4,5}) to the controller for driving the light sources L1, L2, . . . , L8. In the known display device which comprise an ambient illumination system, the known display device may be operated in two distinct modes: in one mode the illumination variation generated by the light source is synchronized with the video-image I1, I2 displayed on the known display device, or in the other mode, the illumination variation is unrelated to a video-image I₁, I₂ and only comprise a predefined sequence of colors to be displayed by the light source. In the display device 200 according to the invention, the ambient illumination system 100 comprises the analyzer 20 which derives the ambilight signal Av, At, (Av_{1,1}, . . . Av_{4,5}), P, (P_{1,1}, . . . P_{4,5}) from the video-image I₁, I₂; the ambient illumination system 100 further displays the illumination variation based on the ambilight signal Av, At, (Av_{1,1}, . . . Av_{4,5}), P, (P_{1,1}, . . . P_{4,5}) while not displaying the video-image I₁, I₂. This enhances the usability of the ambient illumination system 100 according to the invention.

FIG. 2B shows a display device 200 having a single predefined area A which moves within the video-image I₁, I₂ for deriving the ambilight signal Av, At, (Av_{1,1}, . . . Av_{4,5}), P, (P_{1,1}, . . . P_{4,5}). In the embodiment shown in FIG. 2B the predefined area A moves through the video-image I₂ along the path p. The path p may be a user defined path p or a random path p. the path p may also be limited to within a sub-area I_{S1}, I_{S2} of the video-image I₂ in which, for example, the sub-areas I_{S1}, I_{S2} represent a specific range of colors which, for example, are associated with a specific mood of a user.

The single predefined area A as shown in FIG. 2B may further comprise a plurality of further predefined areas (not shown) within the predefined area A at which location the ambilight signal Av, At, (Av_{1,1}, . . . Av_{4,5}), P, (P_{1,1}, . . . P_{4,5}) is derived by the analyzer 20.

The derivation of the ambilight signal Av, At, (Av_{1,1}, . . . Av_{4,5}), P, (P_{1,1}, . . . P_{4,5}) using a predefined area A moving through the video-image I₂ may also be applied when the video-image I₂ is displayed substantially simultaneously with the illumination variation resulting from the derived ambilight signal Av, At, (Av_{1,1}, . . . Av_{4,5}), P, (P_{1,1}, . . . P_{4,5}). In such an embodiment the video-image I₂ is substantially synchronized with the displaying of the video-image I₂ causing a real-time derivation of the ambilight signal Av, At, (Av_{1,1}, . . . Av_{4,5}), P, (P_{1,1}, . . . P_{4,5}) from the shown moving of the predefined area A through the video-image I₂ and the substantially real-time displaying of the illumination variation based on the derived ambilight signal Av, At, (Av_{1,1}, . . . Av_{4,5}), P, (P_{1,1}, . . . P_{4,5}).

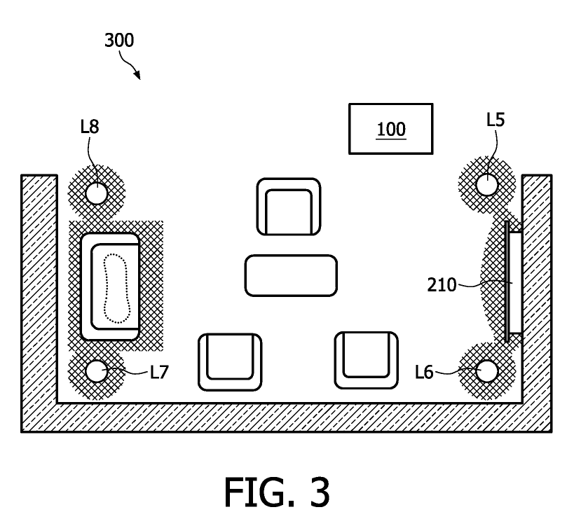

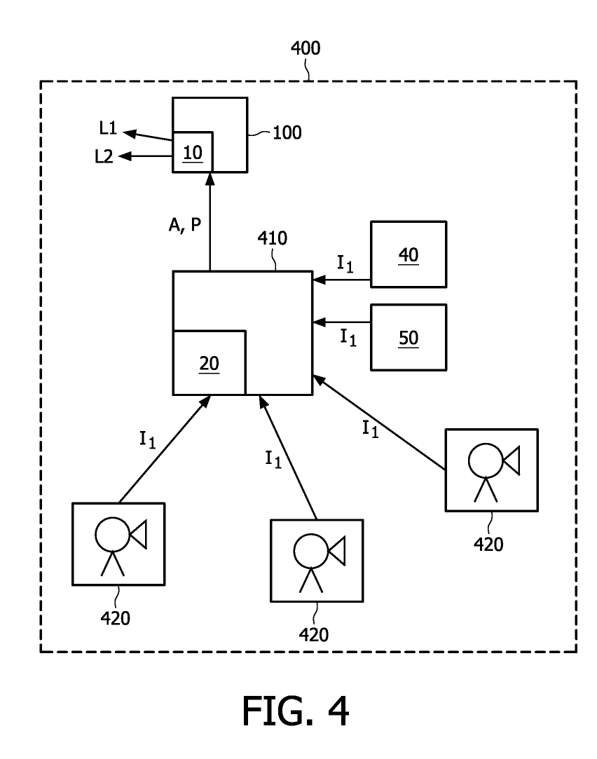

FIG. 3 shows the ambient illumination system 100 comprising a plurality of light sources L1, L2, . . . , L8 distributed throughout a room 300. The illumination system 100 comprises a controller for driving the plurality of light source L1, L2, . . . , L8 to display the illumination variation based on the ambilight signal Av, At, (Av_{1,1}, . . . Av_{4,5}), P, (P_{1,1}, . . . P_{4,5}) from the analyzer 20. In the embodiment shown in FIG. 3, the room comprises a display device 210, for example, comprising a sub-set of light sources L1, L2, L3, L4 to illuminate the surroundings of the display device 210. This sub-set of light sources L2, L3, L4 are driven by the controller to display part of the illumination variation associated with the ambilight signal Av, At, (Av_{1,1}, . . . Av_{4,5}), P, (P_{1,1}, . . . P_{4,5}). The embodiment shown in FIG. 3 further comprise a second set of lights sources L5, L6, L7, L8 which are distributed through the room 300 and are also controlled by the controller 10 of the ambient illumination system 100 for distributing part of the illumination variation based on the ambilight signal Av, At, (Av_{1,1}, . . . Av_{4,5}), P, (P_{1,1}, . . . P_{4,5}). The combination of the sub-set of light sources L1, L2, L3, L4 and the second set of light sources L5, L6, L7, L8 generate an ambient illumination system 100 in which not only the direct surroundings of the display device 210 is illuminated using the ambilight signal Av, At, (Av_{1,1}, . . . Av_{4,5}), P, (P_{1,1}, . . . P_{4,5}) but substantially the whole room 300 is illuminated using the ambilight signal Av, At, (Av_{1,1}, . . . Av_{4,5}), P, (P_{1,1}, . . . P_{4,5}) as derived by the analyzer 20.

FIG. 4 shows a distribution network 400 comprising a server 410 for distributing the ambilight signal Av, At, (Av_{1,1}, . . . Av_{4,5}), P, (P_{1,1}, . . . P_{4,5}). The distribution network 400 comprises a plurality of sources 40, 50, 420 for providing the video-image I₁, I₂ to the analyzer 20 for deriving the ambilight signal Av, At, (Av_{1,1}, . . . Av_{4,5}), P, (P_{1,1}, . . . P_{4,5}). The analyzer 20 is located in the embodiment shown in FIG. 4 in the server 410. Alternatively (not shown), the plurality of sources 40, 50, 420 may comprise an analyzer 20 which derives the ambilight signal Av, At, (Av_{1,1}, . . . Av_{4,5}), P, (P_{1,1}, . . . P_{4,5}) from the video-image I₁, I₂ of the source 40, 50, 420. The server 410 distributes the ambilight signal Av, At, (Av_{1,1}, . . . Av_{4,5}), P, (P_{1,1}, . . . P_{4,5}) throughout the distribution network 400 to, for example, a controller 10 configured for driving the light source L1, L2, . . . , L8 (see FIGS. 1 and 2) while not displaying the video-image I₁, I₂.

The source 40, 50, 420 may be a storage medium 40 or a tuner 50 or, for example, a web-cam 420 located at some remote place for collecting the video-image I₁, I₂ from which the ambilight signal Av, At, (Av_{1,1}, . . . Av_{4,5}), P, (P_{1,1}, . . . P_{4,5}) is derived.

It should be noted that the above-mentioned embodiments illustrate rather than limit the invention, and that those skilled in the art will be able to design many alternative embodiments without departing from the scope of the appended claims.

For example, the ambient light projection system shown in the embodiments is attached to a display device. However, the ambient light projection system may also be arranged separated from the display device, for example, arranged at a wall behind the display device, or even located elsewhere in the room as a lamp or interior decoration element in which the color and/or intensity of the projected light is modulated by the video and/or audio content of the display device.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Ambient illumination system (100) for driving a light source (L1, L2, . . . , L8) to display an illumination variation, the illumination variation being generated using an ambilight signal (Av, At, (Av_{1,1}, . . . Av_{4,5})) derived from a video-image (I1, I2), the ambilight signal (Av, At, (Av_{1,1}, . . . Av_{4,5})) comprising a peak value (P, (P_{1,1}, . . . P_{4,5})) or average value (Av, (Av_{1,1}, . . . Av_{4,5})) of a color and/or intensity from a predefined area (A, (A_{1,1}, . . . A_{4,5})) of the video-image (I1, I2), the ambient illumination system (100) comprising:
an analyzer (20) for deriving the ambilight signal (Av, At, (Av_{1,1}, . . . Av_{4,5}), P, (P_{1,1}, . . . P_{4,5})) from the video-image (I1, I2), and
a controller (10) for driving the light source (L1, L2, . . . , L8) using the ambilight signal (Av, At, (Av_{1,1}, . . . Av_{4,5})) to display the illumination variation while not displaying the video-image (I₁, I₂).

2. Ambient illumination system (100) as claimed in claim 1, wherein the ambient illumination system (100) is configured for receiving the video-image (I₁, I₂) from a source (40, 50, 420).

3. Ambient illumination system (100) as claimed in claim 1, wherein the ambient illumination system (100) further comprises:
a recorder (30) for recording the ambilight signal (Av, At, (Av_{1,1}, . . . Av_{4,5}), P, (P_{1,1}, . . . P_{4,5})) derived from the video-image (I₁, I₂) onto a storage medium (40).

4. Ambient illumination system (100) as claimed in claim 1, wherein the analyzer (20) is configured for deriving a series of peak values (P, (P_{1,1}, . . . P_{4,5})) or a series of average values (Av, (Av_{1,1}, . . . Av_{4,5})) of the predefined area (A, (A_{1,1}, . . . A_{4,5})) from the video-image (I₁, I₂) collected at predetermined time intervals.

5. Ambient illumination system (100) as claimed in claim 4, wherein the analyzer (20) is configured for averaging the derived peak values (P, (P_{1,1}, . . . P_{4,5})) over time to derive the ambilight signal (At), or wherein the analyzer (20) is configured for averaging the derived average value (Av, (Av_{1,1}, . . . Av_{4,5})) over time to derive the ambilight signal (At).

6. Ambient illumination system (100) as claimed in claim 4, wherein the controller (10) is configured for generating interpolation values in-between the peak values (P, (P_{1,1}, . . . P_{4,5})) in the series of peak values (P, (P_{1,1}, . . . P_{4,5})) or in-between the average values (Av, (Av_{1,1}, . . . Av_{4,5})) in the series of average values (Av, (Av_{1,1}, . . . Av_{4,5})) for generating a smooth transition from one peak value (P, (P_{1,1}, . . . P_{4,5})) to the next peak value (P, (P_{1,1}, . . . P_{4,5})) in the series of peak values (P, (P_{1,1}, . . . P_{4,5})) or from one average value (Av, (Av_{1,1}, . . . Av_{4,5})) to the next average value (Av, (Av_{1,1}, . . . Av_{4,5})) in the series of average values (Av, (Av_{1,1}, . . . Av_{4,5})).

7. Ambient illumination system (100) as claimed in any of the claim 4, wherein the controller (10) is configured for adapting a time-scale of the ambilight signal (Av, At, (Av_{1,1}, . . . Av_{4,5}), P, (P_{1,1}, . . . P_{4,5})) to increase or decrease a time required for displaying of the illumination variation.

8. Ambient illumination system (100) as claimed in claim 1, wherein the analyzer (20) is configured for deriving the ambilight signal (Av, At, (Av_{1,1}, . . . Av_{4,5}), P, (P_{1,1}, . . . P_{4,5})) from a sequence of video-images (I₁, I₂).

9. Ambient illumination system (100) as claimed in claim 1, wherein the analyzer (20) is configured for deriving the ambilight signal (Av, At, (Av_{1,1}, . . . Av_{4,5}), P, (P_{1,1}, . . . P_{4,5})) by moving the predefined area (A, (A_{1,1}, . . . A_{4,5})) across the video-image (I₁, I₂).

10. Ambient illumination system (100) as claimed in claim 9, wherein the analyzer (20) is configured for moving of the predefined area (A, (A_{1,1}, . . . A_{4,5})):
along a user defined path (p) within the video-image (I₁, I₂),
along a predefined path (p) within the video-image (I₁, I₂),
along a random path (p) within the video-image (I₁, I₂), or
within a predefined sub-area (I_{S1}, I_{S2}) of the video-image (I₁, I₂).

11. Display device (200) comprising the Ambient illumination system (100) as claimed in claim 1.

12. Method of generating an illumination variation by an ambient illumination system (100), the ambient illumination system being configured for driving a light source (L1, L2, . . . , L8) to display the illumination variation, the illumination variation being generated using a ambilight signal (Av, At, (Av_{1,1}, . . . Av_{4,5}), P, (P_{1,1}, . . . P_{4,5})) derived from a video-image (I₁, I₂), the ambilight signal (Av, At, (Av_{1,1}, . . . Av_{4,5}), P, (P_{1,1}, . . . P_{4,5})) comprising a peak value (P, (P_{1,1}, . . . P_{4,5})) or average value (Av, (Av_{1,1}, . . . Av_{4,5})) of a color and/or intensity from a predefined area (A, (A_{1,1}, . . . A_{4,5})) of the video-image (I₁, I₂), the method comprising the steps of:
deriving the ambilight signal (Av, At, (Av_{1,1}, . . . Av_{4,5}), P, (P_{1,1}, . . . P_{4,5})) from the video-image (I₁, I₂), and
driving the light source (L1, L2, . . . , L8) using the ambilight signal (Av, At, (Av_{1,1}, . . . Av_{4,5}), P, (P_{1,1}, . . . P_{4,5})) to display the illumination variation while not displaying the video-image (I₁, I₂).

13. Method of generating the illumination variation as claimed in claim 13, wherein the step of deriving the ambilight signal (Av, At, (Av_{1,1}, . . . Av_{4,5}), P, (P_{1,1}, . . . P_{4,5})) comprises deriving the ambilight signal (Av, At, (Av_{1,1}, . . . Av_{4,5}), P, (P_{1,1}, . . . P_{4,5})) from a sequence of video-images (I₁, I₂).

14. Method of generating the illumination variation as claimed in claim 13, wherein the step of deriving the ambilight signal (Av, At, (Av_{1,1}, . . . Av_{4,5}), P, (P_{1,1}, . . . P_{4,5})) comprises deriving the ambilight signal (Av, At, (Av_{1,1}, . . . Av_{4,5}), P, (P_{1,1}, . . . P_{4,5})) by moving the predefined area (A, (A_{1,1}, . . . A_{4,5})) across the video-image (I₁, I₂).

15. Method of providing a data service via a data-network (410) for distributing an ambilight signal (Av, At, (Av_{1,1}, . . . Av_{4,5}), P, (P_{1,1}, . . . P_{4,5})) for generating an illumination variation by an ambient illumination system (100), the ambient illumination system (100) being configured for driving a light source (L1, L2, . . . , L8) to display the illumination variation, the illumination variation being generated using the ambilight signal (Av, At, (Av_{1,1}, . . . Av_{4,5}), P, (P_{1,1}, . . . P_{4,5})) derived from a video-image (I₁, I₂), the ambilight signal (Av, At, (Av_{1,1}, . . . Av_{4,5}), P, (P_{1,1}, . . . P_{4,5})) comprising a peak value (P, (P_{1,1}, . . . P_{4,5})) or average value (Av, (Av_{1,1}, . . . Av_{4,5})) of a color and/or intensity from a predefined area (A, (A_{1,1}, . . . A_{4,5})) of the video-image (I₁, I₂), the method comprising the steps of:
deriving the ambilight ^{signal} (Av, At, (Av_{1,1}, . . . Av_{4,5}), P, (P_{1,1}, . . . P_{4,5})) from the video-image (I₁, I₂), and
distributing the ambilight signal (Av, At, (Av_{1,1}, . . . Av_{4,5}), P, (P_{1,1}, . . . P_{4,5})) to the ambient illumination system (100) for driving the light source (L1, L2, . . . , L8) to display the illumination variation while not displaying the video-image (I₁, I₂).
